(19) United States
(12) Patent Application Publication
(10) Pub. No.: US 2022/0154015 A1
(43) Pub. Date: May 19, 2022

(54) SUBSTRATE COATING COMPOSITIONS AND METHODS

(71) Applicant: HONEYWELL INTERNATIONAL INC., Charlotte, NC (US)

(72) Inventors: Jun Liu, Shanghai (CN); Johnny Hu, Shanghai (CN); Yanming Shen, Shanghai (CN); Ya Qun LIU, Shanghai (CN); Ryan Hulse, Charlotte, NC (US)

(73) Assignee: HONEYWELL INTERNATIONAL INC., Charlotte, NC (US)

(21) Appl. No.: 17/506,583

(22) Filed: Oct. 20, 2021

Related U.S. Application Data
(62) Division of application No. 16/435,153, filed on Jun. 7, 2019, now abandoned.
Application No. 16/435,153 is a division of application No. 14/903,742, filed on Jan. 8, 2016, now abandoned.

(51) Int. Cl. C09D 7/20; C08G 65/00; C09D 171/02; C08G 65/336; C09D 5/16; C09D 171/00

(52) U.S. Cl. CPC C09D 7/20; C08G 65/007; C09D 171/02; C09D 171/00; C09D 5/1687; C09D 5/1662; C08G 65/336

(57) ABSTRACT

A coating composition comprising: (a) at least one coating agent comprising a perfluoropolyether-modified al-kyloxysilane polymer; and (b) a carrier composition comprising monochloro, trilluoropropene, wherein the carrier is present in an amount effective to at least partially solvate or at least partially emulsify the coating agent. Such compositions may optionally contain one or more other co-carriers or additives. Also disclosed are methods of coating substrates, in particular substrates having a hard surface such as ceramics or glass, to render them water, oil and/or dirt repellent.

### CROSS REFERENCE TO RELATED APPLICATIONS

This application is a division of U.S. application Ser. No. 16/435,153, filed Jun. 7, 2019 (now pending), which is a division of U.S. application Ser. No. 14/903,742 filed Jan. 8, 2016 (now abandoned), which application is a 371 application of PCT Application No. PCT/CN2013/079513, filed Jul. 17, 2013, the entirety of which is herein incorporated by reference.

### FIELD OF THE INVENTION

This invention relates to coating compositions, methods and systems which include a coating agent and a solvent or carrier for the coating agent. Typically as a result of the application of the composition in the intended manner, the coating agent becomes operative upon or in association with the removal, usually by evaporation, of the solvent or carrier.

### BACKGROUND OF THE INVENTION

Many applications involve the use of a material which acts as a carrier, dispersant, diluent, processing aid, and/or solvent for an active component or components. The carrier/dispersant/diluent/processing aid/solvent (hereinafter referred to sometimes as “carrier” for convenience) facilitates and preferably enhances the delivery and/or functioning of at least one of the active components at the location of intended use, and at the same time such carrier should not negatively interfere with the operation of the active components. Because the carrier will frequently in such situations he released into the open atmosphere upon use, the environmental properties of the carrier materials have become increasingly important as the concern about the environmental impact of man-made materials and activities has risen. For example, during the course of the past several years, substantial effort has been devoted to developing materials which have a much smaller impact on global warming and on depletion of the ozone layer in the field of refrigeration. Furthermore, the release of materials into the atmosphere can have a negative impact on low-level atmospheric conditions, such as smog and haze.

In addition to favorable environmental properties, the material which is used for the carrier preferably also has a desirable but difficult to achieve combination of other properties, depending on the particular application, such as inertness with respect to the active ingredient(s), low toxicity and low flammability, among other properties. In many applications it is also either desirable or essential that the carrier have the ability to at least partially emulsify and/or to preferably at least partially solvate the active ingredient.

One particular application involves surface treating substrates such as glass and ceramics to render such substrates oil and water repellant. The surface of many substrates, including, for example, touch panel display screens, optical lenses, mirrors, and the like, are susceptible to being stained with fingerprints, skin oils, dirt, sweat, cosmetics, and so forth. The use of fluorinated silanes, i.e., silane compounds that have one or more fluorinated groups, for rendering substrates such as glass and ceramics oil and water repellent are known. For example U.S. Pat. No. 8,211,544 describes a method of treating a substrate surface with a surface modifier comprising and organosilicone compound which contains a perfluoropolyether polymer chain block. U.S. Pat. No. 7,294,731 describes a coating composition comprising perfluoropolyether silane. U.S. Pat. No. 7,196,212 describes a surface treating agent comprising perfluoropolyether-modified silane.

The deposition of such coating agents through wet coating methods requires solvents such as perfluorocarbons (e.g., perfluorohexane, perfluoroheptane, and perfluorooctane), fluorine-modified aromatic hydrocarbon solvents (e.g., bis-tritluoromethyl-benzene), partially fluorinated hydrocarbon solvents (e.g., 2H,3H-perfluoropentane) and hydrofluoroethers. Typically, a very dilute solution of the coating polymer dissolved in a fluorinated solvent is coated onto a substrate to result in a very thin layer of coating. As a result, a large amount of solvent is released into the atmospheric environment. Such solvents, however, have a relatively high global warming potential (GWP) (e.g., perfluorohexane has a GWP of 9,300; 2H,3H-perfluoropentane has a GWP of 1,640; perfluorobutyl methyl ether has a GWP of 297; and 1,1,2,2-tetrafluoroethyl-2,2,2-trifluoroethyl ether has a GWP of 580). As global warming becomes more and more of a concern, there is a need in the art for solvents capable of sufficiently dissolving coating polymers and coating a substrate with such polymers that exhibit a low GWP.

These and other needs are satisfied by the present invention.

### SUMMARY OF THE INVENTION

One aspect of the present invention provides a coating composition including a coating agent and a carrier, wherein the carrier is provided in an amount effective to at least partially solvate or at least partially emulsify the coating agent. The carrier comprises a monochloro,trifluoropropene, and preferably 1-chloro-3,3,3-trifluoropropene ((HCF0 -1233zd), and even more preferably trans-1-chloro-3,3,3-trifluoropropene (trans-HCFP0 -1233zd or HCFO-1233zd(E)) and/or cis-1-chloro-3,3,3-trifluoropropene (cis-HCF0-1233zd or HCFO-1233zd(Z)).

The coating agent comprises at least one perfluoropolyether (“PFPE”) polymer modified by an alkyloxysilane. In certain embodiments, the PFPE-modified alkyloxysilane polymer has the general formula I, formula II, or formula III:

Rlf—Si(R)a(X) 3-a (I)

Si(R)a(X)3.a-R2f-S1(R)a(X)3-a (II)

Rlf-Si(R)z(X)2_a-O—Si(Rif)(R)a(X)i-a-O—Si(R)a(X)2-a-Rlf (III)

wherein

R is a monovalent alkyl or aryl radical;

X is a hydrolyzable radical;

a is an integer of 0 to 2;

Rlt is F—(CF2)1-Rf—(CH2)mY(CH2)n—; and

R2f is —(CH2)nY(CH2)m-Rf—(CH2)mY(CH2)n—;

wherein

1 is an integer from 1 to 6;

m is 1 or 2;

n is an integer from 2 to 20;
Y is 0 or a bivalent organic group; and
Rf is a perfluoropolyether group comprising perfluorinated repeating units selected from the group consisting of —(OC3F6)x—, —(OC2F4)y—, —(OCF2)z—, or combination thereof, wherein x, y, and z are each independently an integer from 1 to 200, preferably in the range of 1 to 100, more preferably in the range of from 5 to 50, and even more preferably in the range of from 10 to 30.

In certain embodiments, the coating composition includes a co-carrier. The co-carrier can be a fluorocarbon or non-fluorous co-carrier. Certain preferred fluorocarbon co-carriers include, but are not limited to, perfluorocarbons, hydrofluorocarbons, fluorochlorocarbons, fluoroethers, fluoroketones, and combinations of two or more of these. Certain preferred non-fluorous co-carriers include, but are not limited to, alcohols, ketones, esters, ethers, hydrocarbons, and combinations of two or more of these. Examples of preferred co-carriers include, but are not limited to, perfluorohexane, perfluoroheptane, perfluorooctane, 1,1,1,3,3-pentafluorobutane, perfluorobutyl ether, perfluoroisobutyl ether, perfluorobutyl methyl ether, perfluorobutyl ethyl ether, 1,1,2,2-tetrafluoroethyl-2,2,2-trifluoroethyl ether, methanol, ethanol, acetone, ethyl acetate, hexane, heptane, toluene, xylene, methylcyclohexane, chloroform, cyclohexane, 2,2-dichloropropane, methylene chloride, d-limonene, isoprene, styrene liquid, diisobutyl ketone, diisopropylketone, methyl isobutyl ketone, methyl isopropyl ketone, methyl cyclohexanone, cyclohexanone, isobutyl acetate, isopropyl acetate, butyl acetate, propyl acetate, ethyl acetate, diethyl ether, dimethyl ether, diethylene glycol, 2-ethylhexanol, and combinations of two or more of these.

In another aspect, the present invention provides sprayable compositions comprising a coating composition including a coating agent and a carrier, wherein the carrier is provided in an amount effective to at least partially solvate or at least partially emulsify the coating agent. The carrier comprises a monochloro,trifluoropropene, and preferably 1-chloro-3,3,3-trifluoropropene ((HCFO-1233zd), and even more preferably trans-1 -chloro-3,3,3-trifluoropropene (trans-HCFO-1233zd or HCF)-1233zd(E)) and/or cis-1 -chloro-3,3,3-trifluoropropene (cis-HCFO-1233zd or HCFO-1233zd(Z)). The coating agent comprises at least one perfluoropolyether polymer modified by an alkyloxysilane. In certain embodiments, the PFPE-modified alkyloxysilane polymer has the general formula I, formula II, or formula III as defined above.

In yet another aspect, the present invention provides methods for applying a coating agent to the surface of a substrate. The method includes providing a composition comprising at least one coating agent and a carrier in an amount effect to at least partially solvate or at least partially emulsify the coating agent. Suitable carriers include a monochloro,trifluoropropene, and preferably 1-chloro-3,3,3-trifluoropropene ((HCFO-1233zd), and even more preferably trans-1 -chloro-3,3,3-trifluoropropene (trans-HCFO-1233zd or HCFO-1233zd(E)) and/or cis-1-chloro-3,3,3-trifluoropropene (cis-HCFO-1233zd or HCFO-1233zd(Z)). Suitable coating agents include perfluoropolyether polymers modified by an alkyloxysilane. In certain embodiments, the PFPE-modified alkyloxy silane polymer has the general formula I, formula II, or formula III as defined above. In certain embodiments, the step of removing the carrier from the coating agent is carried out by evaporation. Suitable application steps include spray coating, dip coating, spin coating, pouring, brush coating, and immersing.

### DETAILED DESCRIPTION OF PREFERRED EMBODIMENTS

The present invention provides compositions, methods and systems which comprise one or more coating agents and which utilize as a carrier a monochloro,trifluoropropene, and preferably 1-chloro-3,3,3-trifluoropropene ((HCFO-1233zd), and even more preferably trans-1-chloro-3,3,3-trifluoropropene (trans-HCFO-1233zd or HCFO-1233zd(E)) and/or cis-1-chloro-3,3,3-trifluoropropene (cis-HCFO-1233zd or HCFO-1233zd(Z)). As used herein the term “coating agent” refers to any one or more components of the composition which provide, contribute to and/or enhance the intended function of the composition, method or system once the composition has been formed into a coating. In certain preferred embodiments, the coating once formed is intended to perform a water and/or oil repellent function. The term “carrier” is used herein generically to refer to any one or more components of the composition, system or method whose primary function is to provide a means for containing the coating agent, preferably in relatively dilute condition, and/or for aiding or contributing to the ease of application and/or effectiveness of the coating composition at the location of intended use.

Applicants have unexpectedly found that the preferred compositions, methods and systems of the present invention provide highly favorable and desirable environmental properties, including preferably low GWP, low ODP and/or low VOC. In certain embodiments, the carrier of the present invention has a GWP of less than 100, preferably less than 50, more preferably less than 20, even more preferably less than 10, and even more preferably less than 5. Although the carrier component of the present invention generally does not act directly to form or produce the intended final product, it will be appreciated by those skilled in the art that the effectiveness of the carrier may nevertheless have an indirect impact on the properties of the final product by virtue of its effectiveness as a carrier, such as by evenly distributing the coating agent at the intended target location and/or leaving the coating agent in a more effective condition to perform its intended function.

In addition to providing favorable and desirable environmental properties, the monochloro,trifluoropropene compounds described herein for use as the carrier possess a desirable but difficult to achieve mosaic of other properties, preferably and particularly when used in combination with the preferred coating agent comprising the polymers according to formula I, formula II, or formula III as described below, including substantial inertness with respect to the coating agent, low toxicity and low flammability, among other properties. In certain applications and embodiments, the carrier in combination with the preferred coating agent contributes to one or more of the following properties of the composition, method or system: flexibility of the material after removal of the carrier and curing or further processing of the coating agent, quality finish of the material after removal of the carrier and curing or further processing of the coating agent, quick dry times, and easy and/or effectiveness of application of the composition. Applicants have further unexpectedly found that the surface of preferred glass or ceramic substrates in accordance with the present invention, after application of the coating compositions of the present invention, demonstrates a water repellency as measured by a water contact angle of over 90°, preferably over 100°, and more preferably over 105° . Applicant have also found that the surface of such substrates, after application of the coating compositions of the present invention, demonstrates an oil repellency as measured by a hexane contact angle of over 50°, preferably over 60°, and more preferably over 65°. In addition, application of coating compositions in accordance with certain preferred aspects of the present invention to the surface of preferred substrates alters the friction coefficient of the substrate so as to allow for smoother travel by, for example, a person's finger, across the surface of the substrate.

It is also either desirable or essential that the carrier have the ability to at least partially emulsify and/or to preferably at least partially solvate the coating agent. For substrate surface treatment applications, the ability of the carrier/coating agent combination to form an at least partially soluble and/or at least partially emulsifiable mixture can be highly desirable. Applicants have found that many preferred embodiments of the present invention provide a fluid composition which is at least a partially soluble and/or partially emulsifiable mixture, and in even more preferred applications is substantially fully soluble and/or substantially fully emulsifiable. Furthermore, the compositions, methods and systems of the present invention have the advantage in many embodiments of providing the ability of the carrier to be readily removed with little or no additional steps after application to the material. Thus, in preferred compositions, methods and systems, the time required to cure/develop the coating agent is relatively low and requires relatively little, and preferably no additional energy after the application step.

The coating agent can be a wide variety of perfluoropolyether (“PFPE”) polymer materials and combinations according to the broad scope of the present invention. In certain embodiments, the polymer is a PFPE modified with an alkyloxysilane. Examples of such PFPE-modified alkyloxysilanes suitable for use as coating agents in the present invention include those described in U.S. Pat. Nos. 7,196,212, 7,294,731, and 8,211,544. While not wishing to be bound by theory, applicants believe that the PFPE, when applied in accordance with the compositions and methods of the present invention, provides the surface of the preferred substrates with a low friction coefficient and anti-staining function due to its chain flexibility, hydrophobicity, and oleophobicity; on the other hand, the alkyloxysilane group can react with the surface of the substrate to improve binding of the PFPE polymer onto the surface.

The PFPE-modified alkyloxysilane compounds according to the present invention are prepared, for example, by effecting addition reaction of a hydrosilane having a hydrolyzable radical to a perfluoropolyether having alpha-unsaturation at either end in the presence of a platinum group catalyst according to a conventional hydrosilation process. The resulting PFPE-modified alkyloxysilanes of the present invention have the following general formula I, formula II, or formula III:

R1fSi(R)a(X)3-a (I)

Si(R)a(X)3-a_a-R2f-Si (R)a(X)3-a (II)

Rlf-Si(R)z(X)2 a-O—Si(R1f)(R)a(X)1-a-O—Si(R)a(X)2 a-Rlf (III)

wherein

R is a monovalent alkyl or aryl radical;

X is a hydrolyzable radical;

a is an integer of 0 to 2;

Rlf is F—(CF2)1-Rf—(CH2)mY(CH2)n—; and

R2f is —(CH2)nY(CH2)m-Rf—(CH2)mY(CH2)n—;

wherein

1 is an integer from 1 to 6;

m is 1 or 2;

n is an integer from 2 to 20;

Y is 0 or a bivalent organic group; and

Rf is a perfluoropolyether group comprising perfluorinated repating units selected from the group consisting of —(OC3F6)x—, —(OC2F4)y—, —(OCF2)z—, or combination thereof, wherein x, y, and z are each independently an integer from 1 to 200, preferably in the range of 1 to 100, more preferably in the range of from 5 to 50, and even more preferably in the range of from 10 to 30. Illustrative examples of suitable alkyl radicals include lower alkyl radicals of 1 to 4 carbon atoms or phenyl radicals, for example, methyl, ethyl, propyl, and phenyl.

Applicants have further discovered that cis- or trans-HCF0-1233zd may be specifically selected in coating applications depending upon its properties (e.g., flammability, Kauri-Butanol (KB) number, or the like), the method of application (e.g., sprayablc, non-sprayablc, and so forth), and/or its solubility with the coating agent. By way of non-limiting example, in certain spray coating applications the trans-HCFO-1233zd isomer may be preferred because of its lower boiling point, but the cis-isomer may also be provided, as necessary, to assist with solubility of the coating agent. A low boiling point results in fast evaporation, which in turn results in positive coating performance. In certain non-spray applications (e.g., dipping, pouring, brushing, immersing, and so forth), it is particularly desirable that the carrier/coating agent combination form an at least partially soluble and or at least partially emulsifiable mixture and that the selection of the isomer used may be based upon its solubility with the coating agent. In certain non-spray applications, the cis-HCFO-1233zd isomer may be preferred because it exhibits better solubility with coating agents, particularly coating agents within the general categories provided above. Alternatively, in some non-spray applications where the trans-HCFO-1233zd isomer may be preferred or otherwise used, it may be provided alone, or in certain embodiments, in conjunction with one or more co-carriers (where necessary), particularly one or more co-carriers that improve solubility or miscibility of trans-1233zd with the coating agent.

Applicants have surprisingly and unexpectedly discovered that the Kauri-Butanol (KB) number of cis-HCFO-1233zd is 34 and that the KB number of trans-HCFO-1233zd is 25. Thus, the cis-isomer has a KB number that is over 30% higher than the trans-isomer, suggesting that it, at least in certain application, may be a better solvent. Accordingly, and in certain aspects of the present invention, the monochloro,trifluoropropene selected, and in particular the HCFO-1233zd isomer selected, has a KB number of greater than 30. In further embodiments, the cis-HCFO-1233zd isomer may be specifically selected, alone or in conjunction with the trans-isomer, to provide a desired solubility to the active agent.

In addition to the Kauri-Butanol values and low boiling points discussed above, HCFO-1233zd also exhibits a very low surface tension (e.g., trans-HCFO-1233zd has a surface tension of about 12.7 dynes/cm). These properties (i.e., low surface tension, low boiling point, and advantageous Kauri Butanol values) provide HCFO-1233zd with a balance of penetration ability, volatility, and solvent power that may be adjusted depending on the isomer utilized, or proportions of isomer utilized. Applicants note that in the embodiments disclosed herein where one particular isomer may be preferred does not necessarily preclude the inclusion of the other or both isomers. Rather, it simply identifies qualities of one isomer that may be preferred for that application. Either isomer can be the provided in such applications alone, or otherwise in an isomeric mixture.

Although it is contemplated that the carrier of the present invention will comprise a major proportion of the composition, in preferred embodiments the carrier will comprise from about 5% to about 99.99%, preferably at least about 50% by weight, and more preferably at least about 80% by weight of the composition. In certain highly preferred embodiments, the coating compositions of the present invention comprise from about 99.8% by weight to about 99.95% by weight of monochloro,trifluoropropene, and from about 0.05% by weight to about 0.2% by weight of the coating agent. It will be appreciated that other material may be included in the carrier in order to supplement or enhance the overall performance of the composition, method or system. The inclusion of any and all of such supplemental and additional materials in the carrier is within the broad scope of the present invention.

Examples of additional or supplemental materials that may be used in combination with the monchloro,trifluoropropene carrier component of the present invention include co-carriers such as other hydrocarbons, other fluorocarbons, including other flu orochlorocarbons, fluorocthcrs, fluorokctoncs, alcohols, ketones and/or formates. As mentioned above, these additional or supplemental components may be added, for example, to decrease the overall environmental impact and/or improve the performance of the composition, method or system. Other examples include additives which improve the abrasion resistance and/or the hydrophobicity and oleophobicity of the coating layer. It is contemplated, although not generally preferred, that the coating methods may require the application of two or more different compositions or material to achieve the desired final finish or coated surface. In such cases the systems of the present invention will comprise the present coating composition together with such additional materials or compositions which are intended to be or which are used together with the present coating compositions to achieve a coating according to the present invention.

In certain embodiments of the present invention wherein the coating composition further includes a co-carrier, suitable co-carriers may include other fluorocarbons and non-fluorous co-carriers. Examples of fluorocarbons include, but are not limited to, perfluorocarbons (such as perfluorohexane), hydrofluorocarbons (such as 1,1,1,3,3-pentafluorobutane), fluorochlorocarbons, fluoroethers (such as 1,1,2,2-tetrafluoroethyl-2,2,2-trifluoroethyl ether, perfluorobutyl methyl ether, and perfluorobutyl ethyl ether), and fluoroketones. Examples of non-fluorous co-carriers include, but are not limited to, alcohols (such as methanol and ethanol), ketones (such as acetone), esters (such as ethyl acetate), hydrocarbons (such as hexane, hcptane, toluene, xylcnc, mcthylcyclohcxanc), chlorocarbons (such as chloroform, cyclohexane, 2,2-dichloropropane, methylene chloride), formates, naphtha, terpene-based solvents (such as d-limonene), other high evaporation rate organic materials (such as isoprene, styrene liquid, diisohutyl ketone, diisopropylketone, methyl isobutyl ketone, methyl isopropyl ketone, methyl cyclohexanone, cyclohexanone, isobutyl acetate, isopropyl acetate, butyl acetate, propyl acetate, ethyl acetate, diethyl ether, dimethyl ether, diethylene glycol, 2-ethylhexanol) and mixtures of any of these with or without further materials used as co-carriers. In certain embodiments in which a co-carrier is included with the carrier, the co-carrier is present in an amount up to about 10 percent by weight, preferably about 30 percent by weight, more preferably about 50 percent by weight, and even more preferably about 70 percent by weight of the carrier.

The coating methods of the present invention comprise providing a coating composition as described herein and applying the coating composition to the substrate, body and/or surface to be coated, wherein the coating agent is capable of forming a coating or film upon delivery of the composition to the site of use, more preferably upon removal of, even more preferably upon evaporation of, at least a portion of the carrier. The PFPE -modified alkyloxysilane can be dissolved in HCFO-1233zd, optionally in the presence of one or more additional co-carriers and additives as described above. In forming a coating, the composition maybe applied by well-known techniques such as brush coating, dipping, spray coating, spin coating, and evaporation. In certain embodiments, a curing step is utilized to improve coating performance. The optimum treating temperature varies with a particular treating technique, although a temperature from room temperature (about 25° C.) to about 150° C. is desirable. It is understood that appropriate treating conditions are selected on every application because the treating conditions vary depending on the particular coating agent and additives utilized.

In certain embodiments, the methods comprise a further step which will aid, enhance or achieve removal of at least a substantial portion of the carrier from the substrate, body and/or surface so as to allow or enhance development of the desired coating by the coating agent. Although such further step may take many forms according to the present methods, in many applications such step simply comprises allowing the coating composition once applied to be exposed to the environment, which in many preferred embodiments will result in evaporation of at least a portion, and preferably a major proportion, and even more preferably substantially all of, the monochloro,trifluoropropene. It will be appreciated that in some embodiments evaporation will be enhanced by heating of the coating composition once it is applied, which heating step may also provide additional benefits, for example by helping to accelerate development/curing of the coating and/or develop desirable properties in the coating once formed. The coating method may also include a polishing step to remove excess material.

Various substrates can be treated with the surface treating composition of the present invention. Suitable substrates include paper, fabric, metals, metal oxides, glass, plastics, porcelain, and ceramics. Articles with surfaces to which the surface coating agent may be beneficially applied include optical members such as eyeglass lenses and anti-reflection filters (coatings for preventing fingerprint and great contamination); displays; sanitary ware such as bathtubs and washbowls (water repellent, and antifouling coatings); glazing and head lamp covers in vehicles such as automobiles, trains and aircraft (antifouling coatings); building exteriors (water repellent, antifouling coatings); kitchen ware (coatings for preventing oil contamination); telephone booths (water repellent, antifouling, anti-sticking coatings); and artistic objects (water and oil repellent, anti-fingerprint coatings); and compact discs and DVDs (coating for preventing fingerprint). The surface coating agent of the invention is especially suited to form coatings on optical members such as lenses and filters to impart antireflection and antifouling properties thereto.

Treatment of such substrates results in rendering the treated surface less retentive of soil and more readily cleanable due to the oil and water repellent nature of the coated surfaces. The desirable properties arc maintained despite extended exposure or use and repeated cleanings because of the high degree of durability of the coated surface as can be obtained by application of the coating compositions of the present invention.

The following examples are provided for the purpose of illustrating the present invention but without limiting the scope thereof.

### EXAMPLES

### Example 1

Dip Coating of Glass Substrate with Example Coating Composition 1

1 gram of Dow Corning 2700 coatings, which is a 20% concentrated solution of perfluoropolyether functional trimethoxysilane (CAS No.: 870998-78-0) in a mixture solvent of ethylperfluoroisobutylether and ethylperfluorobutylether, was diluted by 199 grams of trans-1-chloro-3,3,3-trifluoropropene in a beaker. A glass chip was dipped into the solvent and then slowly drawn out of the solution. The glass chip was heated to 120° C. for 20 mins. Water contact angle on the treated surface of the glass was measured to be 108 degrees.

### Example 2

### Spray Coating of Glass Substrate with Example Coating Composition 1

1 gram of Dow Corning 2700 coatings, which is a 20% concentrated solution of perfluoropolyether functional trimethoxysilane (CAS No.: 870998-78-0) in a mixture solvent of ethylperfluoroisobutylether and ethylperfluorobutylether, was diluted by 199 grams of trans-1-chloro-3,3,3-trifluoropropene in a beaker. The diluted solution was then loaded into a hand sprayer (Iwata LPH-50) and sprayed onto the surface of a glass surface pre-cleaned with plasma (to increase the surface activity and adhesion with coating). The glass was heated to 120° C. for 20 mins. Water contact angle on the treated surface of the glass was measured to be 111 degrees. The coated glass was rubbed with #0000 teel wool under 1 kg force for 2000 cycles by a Taber-5900 reciprocating abraser. Water contact angle after abrasion test was 103 degrees.

### Example 3

### Spray Coating of Glass Substrate with Example Coating Composition 2

0.1 gram of Fluorolink S10 (a perfluoropolyethers with ethoxysilane terminal groups supplied by Solvay Solexis) is dissolved in 100 grams of trans-1-chloro-3,3,3-trifluoropropene in a beaker. The solution was then loaded into a hand sprayer (Iwata LPH-50) and sprayed onto the surface of a glass surface pre-cleaned with solvent. The glass was heated to 120° C. for 20 mins. Water contact angle on the treated surface of the glass was measured to be 96 degree.

### Example 4

Spray Coating of Glass Substrate with Example Coating Composition 3

1 gram of Shinetsu KY-178 coatings, which is a 20% concentrated solution of perfluoropolyether modified polysiloxane in a mixture solvent of ethylperfluoroisobutylether and ethylperfluorobutylether, was diluted by 199 grams of trans-1-chloro-3,3,3-trifluoropropene in a beaker. The diluted solution was then loaded into a hand sprayer (Iwata LPH-50) and sprayed onto the surface of a glass surface pre-cleaned with solvent. The glass was heated to 120° C. for 20 minutes. Water contact angle on the treated surface of the glass was measured to be 109 degree.

### Example 5

### Solubility of Coating Agent in Example Carrier

Trans-1-chloro-3,3,3 -trifluoropropene was mixed with anhydrous ethanol by a ratio of 90/10 wt/wt in a beaker. 1 gram of Dow Corning 2700 coatings was mixed with 199 grams of the mixture solvent of trans-1 -chloro-3,3,3-trifluoropropene and ethanol in a beaker. Because of the limited solubility of the perfluoropolyether functional trimethoxysilane in the solvent mixture, part of the PFPE polymer precipitate out of the solution. After phase separation, about 10cc of the upper clear phase was transferred to a weighted watch glass and heated slowly to evaporate the solvent. The watch glass was weighed again to calculate how much PFPE polymer was dissolved in the 10 cc solution. The solubility of the PFPE polymer in the mixture solvent of trans-1-chloro-3,3,3-trifluoropropene and ethanol was calculated. The same test had was performed with different ratios of trans-1-chloro-3,3,3-trifluoropropene and with different co-solvents, the results of which are shown in Table 1 below.

TABLE 1
The solubility of Dow Corning perfluoropolyether functional trimethoxysilane
in the mixture of trans-1-chloro-3,3,3-trifluoropropene and co-solvents.

| Co-solvent | | | | | | Ethyl |
|---|---|---|---|---|---|---|
| wt % | Ethanol | Acetone | Hexane | Toluene | Chloroform | Acetate |
| 10 | 0.0910% | 0.0940% | 0.0980% | 0.0960% | 0.0920% | 0.0950% |
| 30 | 0.0660% | 0.0630% | 0.0730% | 0.0580% | 0.0760% | 0.0730% |
| 50 | 0.0290% | 0.0250% | 0.0510% | 0.0240% | 0.0430% | 0.0410% |
| 70 | 0.0039% | 0.0120% | 0.0270% | 0.0097% | 0.0270% | 0.0200% |
| 90 | 0.0014% | 0.0096% | 0.0180% | 0.0085% | 0.0160% | 0.0097% |
| 100 | 0.0009% | 0.0087% | 0.0130% | 0.0074% | 0.0120% | 0.0091% |

### Example 6

### Water Contact Angle of Glass Substrates After Spray Coating with Example Coating Compositions

1 gram of Dow Corning 2700 coatings was mixed with 199 grams of the mixture of trans-1-chloro-3,3,3-trifluoropropene and co-solvent in a beaker. The diluted solution was then loaded into a hand sprayer (Iwata LPH-50) and sprayed onto the surface of a glass surface pre-cleaned with solvent. The glass was heated to 120° C. for 20 mins. Water contact angle on the treated surface of the glass was measured, the results of which are shown in Table 2 below.

TABLE 2
The water contact angle of glass surface coated with Dow Corning
2700 coating using different ratio of mixture of trans-1-chloro-
3,3,3-trifluoropropene and co-solvents as dilution solvent.

| Co-solvent | | | | | | Ethyl |
|---|---|---|---|---|---|---|
| wt % | Ethanol | Acetone | Hexane | Toluene | Chloroform | Acetate |
| 10 | 108 | 111 | 110 | 109 | 111 | 112 |
| 30 | 103 | 106 | 110 | 109 | 109 | 110 |
| 50 | 101 | 102 | 107 | 104 | 106 | 107 |
| 70 | 75 | 97 | 103 | 92 | 104 | 100 |
| 90 | 66 | 93 | 98 | 91 | 97 | 92 |
| 100 | 62 | 92 | 98 | 87 | 97 | 93 |

### Example 7

### Measurement of Kauri-Butanol Number

Measurement of Kauri-Butanol (KB) number was performed in the lab for both trans-1233zd and cis-1233zd using the ASTM method (D1133 Standard Test Method for Kauri-Butanol Value of Hydrocarbon Solvents). Kauri-Butanol number of a solvent is a measure of how well Kauri-gum resin solution is dissolved in a solvent and is used widely in industry to compare solvency of compounds. Kauri-butanol solution was obtained from Fisher Scientific. Both trans-1233zd & cis-1233zd were titrated in to the solution which were kept in a 20 cc vial with septum screw cap. KB number for trans-1233zd was found to be 25 and KB number for cis-1233zd was found to be 34. Unexpectedly the KB value of cis-1233zd increased by >30% over the KB value of the trans-1233zd. CFC-113 which was a widely used solvent in a variety of cleaning applications including but not limited to electronics cleaning, dry cleaning, metal cleaning and deposition had a KB value of 31. Cis-1233zd would be a preferred solvent due to its higher KB value when looking at electronics cleaning, dry cleaning, metal cleaning and deposition.

What is claimed is:

1. A coating composition for forming a water repellant coating on a substrate comprising:
(a) at least one coating agent comprising at least one perfluoropolyether-modified alkyloxysilane polymer; and
(b) a carrier comprising at least about 70% by weight of trans-1-chloro-3,3,3-trifluoropropene (trans-HCFO-1233zd) and being effective to at least partially solvate or at least partially emulsify the coating agent.

2. The composition of claim 1, wherein said perfluoropolyether-modified alkyloxy silane comprises a compound of formula I, formula II, or formula III:
R¹_{f}-Si(R)ₐ(X)₃₋ₐ (I)
Si(R)ₐ(X)₃₋ₐ—R²_{f}—Si(R)ₐ(X)₃₋ₐ (II)
R¹_{f}—Si(R)_{z}(X)₂₋ₐ-O—Si(R¹_{f})(R)ₐ(X)₁₋ₐ-O—Si(R)ₐ(X)₂₋ₐ—R¹_{f} (III)
wherein
R is a monovalent alkyl or aryl radical;
X is a hydrolyzable radical;
a is an integer of 0 to 2;
R¹_{f} is F—(CF₂)₁—R_{f}—(CH₂)ₘY(CH₂)ₙ—; and
R²_{f} is —(CH₂)ₙY(CH₂)ₘ—R_{f}—(CH₂)ₘY(CH₂)ₙ—
wherein
1 is an integer from 1 to 6;
m is 1 or 2;
n is an integer from 2 to 20;
Y is O or a bivalent organic group; and
R_{f} is a perfluoropolyether group comprising perfluorinated repating units selected from the group consisting of —(OC₃F₆)ₓ—, —(OC₂F₄)_{y}—, —(OCF₂)_{z}—, or combination thereof, wherein x, y, and z are each independently an integer from 1 to 200.

3. The composition of claim 1 further comprising a co-carrier selected from the group consisting of fluorocarbon co-carriers and non-fluorous co-carriers.

4. The composition of claim 3 comprising a fluorocarbon co-carrier selected from the group consisting of perfluorocarbons, hydrofluorocarbons, fluorochlorocarbons, fluoroethers, fluoroketones, and combinations of two or more of these.

5. The composition of claim 3 comprising a non-fluorous co-carrier selected from the group alcohols, ketones, esters, ethers, hydrocarbons, and combinations of two or more of these.

6. The composition of claim 3 comprising a co-carrier selected from the group consisting of 1,1,1,3,3-pentafluorobutane, perfluorohexane, perfluoroheptane, perfluorooctane, perfluorobutyl ether, perfluoroisobutyl ether, 1,1,2,2-tetrafluoroethyl-2,2,2-trifluoroethyl ether, methanol, ethanol, acetone, ethyl acetate, hexane, heptane, toluene, xylene, methylcyclohexane, chloroform, cyclohexane, 2,2-dichloropropane, methylene chloride, d-limonene, isoprene, styrene liquid, diisobutyl ketone, diisopropylketone, methyl isobutyl ketone, methyl isopropyl ketone, methyl cyclohexanone, cyclohexanone, isobutyl acetate, isopropyl acetate, butyl acetate, propyl acetate, ethyl acetate, diethyl ether, dimethyl ether, diethylene glycol, 2-ethylhexanol, and combinations of two or more of these.

7. A sprayable composition comprising the composition of claim 1.

8. The sprayable composition of claim 7, wherein said carrier consists essentially of trans-1-chloro-3,3,3-trifluoropropene (trans-HCFO-1233zd).

9. The sprayable composition of claim 7, wherein said perfluoropolyether-modified alkyloxysilane comprises a compound of formula I, formula II, or formula III:
R¹_{f}—Si(R)ₐ(X)₃₋ₐ (I)
Si(R)ₐ(X)₃₋ₐ—R²_{f}—Si(R)ₐ(X)₃₋ₐ (II)
R¹_{f}—Si(R)_{z}(X)₂₋ₐ-O—Si(R¹_{f})(R)ₐ(X)₁₋ₐ—O—Si(R)ₐ(X)₂₋ₐ—R¹_{f} (III)
wherein
R is a monovalent alkyl or aryl radical;
X is a hydrolyzable radical;
a is an integer of 0 to 2;
R¹_{f} is F—(CF₂)₁—R_{f}—(CH₂)ₘY(CH₂)ₙ—; and
R²_{f} is —(CH₂)ₙY(CH₂)ₘ—R_{f}—(CH₂)ₘY(CH₂)ₙ;
wherein
1 is an integer from 1 to 6;
m is 1 or 2;
n is an integer from 2 to 20;
Y is O or a bivalent organic group; and
R_{f} is a perfluoropolyether group comprising perfluorinated repating units selected from the group consisting of —(OC₃F₆)ₓ—, —(OC₂F₄)_{y}—, —(OCF₂)_{z}—, or combination thereof, wherein x, y, and z are each independently an integer from 1 to 200.

10. A method for applying a coating agent to the surface of a substrate to form a water repellant coating on the substrate comprising:
(a) providing a composition comprising (i) at least one coating agent, and (ii) a carrier in an amount effective to at least partially solvate or at least partially emulsify the coating agent, said coating agent comprising at least one perfluoropolyether-modified alkyloxysilane, and said carrier comprising at least about 70% by weight of trans-1-chloro-3,3,3-trifluoropropene (trans-HCFO-1233zd);
(b) applying the composition to the surface of a substrate; and
(c) removing the carrier from the coating agent to form a coating having a water repellency as measured by a water contact angle of greater than about 105°.

11. The method of claim 10, wherein said carrier comprises at least about 90% by weight of trans-1-chloro-3,3,3-trifluoropropene (transHCFO-1233zd).

12. The method of claim 11, wherein said carrier consists essentially of trans-1-chloro-3,3,3-trifluoropropene (trans-HCFO-1233zd).

13. The method of claim 10, wherein said perfluoropolyether-modified alkyloxysilane comprises a compound of formula I, formula II, or formula III:
R¹_{f}—Si(R)ₐ(X)₃₋ₐ (I)
Si(R)ₐ(X)₃₋ₐ—R²_{f}—Si(R)ₐ(X)₃₋ₐ (II)
R¹_{f}—Si(R)_{z}(X)₂₋ₐ—O—Si(R¹_{f})(R)ₐ(X)₁₋ₐ—O—Si(R)ₐ(X)₂₋ₐ—R¹_{f} (III)
wherein
R is a monovalent alkyl or aryl radical;
X is a hydrolyzable radical;
a is an integer of 0 to 2;
R¹_{f} is F—(CF₂)₁—R_{f}—(CH₂)ₘY(CH₂)ₙ—; and
R²_{f} is —(CH₂)ₙY(CH₂)ₘ—R_{f}—(CH₂)ₘY(CH₂)ₙ—;
wherein
1 is an integer from 1 to 6;
m is 1 or 2;
n is an integer from 2 to 20;
Y is O or a bivalent organic group; and
R_{f} is a perfluoropolyether group comprising perfluorinated repating units selected from the group consisting of —(OC₃F₆)ₓ—, —(OC₂F₄)_{y}—, —(OCF₂)_{z}—, or combination thereof, wherein x, y, and z are each independently an integer from 1 to 200.

14. The method of claim 10, wherein the carrier is removed by evaporation.

15. The method of claim 10, wherein the applying step is selected from the group consisting of spray coating, dip coating, spin coating, pouring, brush coating, and immersing.

16. The method of claim 10, wherein the applying step is selected from the group consisting of spray coating, dip coating, spin coating and immersing.

17. The method of claim 1, wherein said carrier comprises at least about 90% by weight of trans-chloro-3,3,3-trifluoropropene (transHCFO-1233zd).
